(19) United States
(12) Patent Application Publication
(10) Pub. No.: US 2018/0271015 A1
(43) Pub. Date: Sep. 27, 2018

(54) Combine Harvester Including Machine Feedback Control

(71) Applicant: Blue River Technology Inc., Sunnyvale, CA (US)

(72) Inventors: Lee Kamp Redden, Palo Alto, CA (US); Wentao Yu, Dubuque, IA (US); Erik Ehn, Sunnyvale, CA (US); James Michael Fleming, San Francisco, CA (US)

(21) Appl. No.: 15/927,980

(22) Filed: Mar. 21, 2018

Related U.S. Application Data
(60) Provisional application No. 62/474,563, filed on Mar. 21, 2017.
(60) Provisional application No. 62/475,118, filed on Mar. 22, 2017.

(51) Int. Cl. A01D 41/127; G05B 13/02

(52) U.S. Cl. CPC A01D 41/127; A01D 45/02; G05B 13/027

(57) ABSTRACT

A combine harvester (combine) includes any number of components to harvest plants as the combine travels through a plant field. The components take actions to harvest plants or facilitate harvesting plants. The combine includes any number of sensors to measure the state of the combine as the combine harvests plants. The combine includes a control system to generate actions for the components to harvest plants in the field. The control system includes an agent executing a model that functions to improve the performance of the combine harvesting plants. Performance improvement can be measured by the sensors of the combine. The model is an artificial neural network that receives measurements as inputs and generates actions that improve performance as outputs. The artificial neural network is trained using actor-critic reinforcement learning techniques.

### CROSS-REFERENCE TO RELATED APPLICATION

This application claims the benefit of U.S. Provisional Application No. 62/474,563 filed Mar. 21, 2017 and U.S. Provisional Application 62/475,118, filed Mar. 22, 2017 the contents of which are hereby incorporated in reference in their entirety.

### FIELD OF DISCLOSURE

This application relates to a system for controlling a combine harvester in a plant field, and more specifically to controlling the combine using reinforcement learning methods.

### DESCRIPTION OF THE RELATED ART

Traditionally, combines are manually operated vehicles where machine includes manual or digital inputs allowing the operator to control the various settings of the combine. More recently, machine optimization programs have been introduced that purport to reduce the need for operator input. However, even these algorithms fail to account for a wide variety of machine and field conditions, and thus still require a significant amount of operator input. In some machines, the operator determines which machine performance parameter is unsatisfactory (sub-optimal or not acceptable) and then manually steps through a machine optimization program using various control techniques. This process takes considerable time and requires significant operator interaction and knowledge. Further, it prevents the operator from monitoring the field operations and being aware of his surroundings while he is interacting with the machine. Thus, a combine that will improve or maintain the performance of the combine with less operator interaction and distraction is desirable.

### SUMMARY

A combine harvester (combine) can include any number of components to harvest plants as the combine travels through a plant field. A component, or a combination of components, can take an action to harvest plants in the field or an action that facilitates the combine harvesting plants in the field. Each component is coupled to an actuator that actuates the component to take an action. Each actuator is controlled by an input controller that is communicatively coupled to a control system for the combine. The control system sends actions, as machine commands, to the input controllers which causes the actuators to actuate their components. Thus, the control system generates actions that cause components of the combine to harvest plants in the plant field.

The combine can also include any number of sensors to take measurements of a state of the combine. The sensors are communicatively coupled to the control system. A measurement of the state generates data representing a configuration or a capability of the combine. A configuration of the combine is the current setting, speed, separation, position, etc. of a component of the machine. A capability of the machine is a result of a component action as the combine harvests plants in the plant field. Thus, the control system receives measurements about the combine state as the combine harvests plants in the field.

The control system can include an agent that generates actions for the components of the combine that improves combine performance. Improved performance can include a quantification of various metrics of harvesting plants using the combine including the amount of harvested plant, the quality of harvested plant, throughput, etc. Performance can be measured using any of the sensors of the combine.

The agent can include a model that receives measurements from the combine as inputs and generates actions predicted to improve performance as an output. In one example, the model is an artificial neural network (ANN) including a number of input neural units in an input layer and a number of output neural units in an output layer. Each neural unit of the input layer is connected by a weighted connection to any number of output neural units of the output layer. The neural units and weighted connections in the ANN represent the function of generating an action to improve combine performance from a measurement. The weighted connections in the ANN are trained using an actor-critic reinforcement learning model.

### BRIEF DESCRIPTION OF DRAWINGS

FIGS. 1A and 1B are illustrations of a machine for manipulating plants in a field, according to one example.

FIG. 2 is an illustration of a combine including its constituent components and sensors, according to one example embodiment.

FIGS. 3A and 3B are illustration of a system environment for controlling the components of a machine configured to manipulate plants in a field, according to one example embodiment.

FIG. 4 is an illustration of the agent/environment relationship in reinforcement learning systems according to one embodiment.

FIG. 5A-5E are illustrations of a reinforcement learning system, according to one embodiment.

FIG. 6 is an illustration of an artificial neural network that can be used to generate actions that manipulates plant and improves machine performance, according to one example embodiment.

FIG. 7 is a flow diagram illustrating a method for generating actions that improve combine performance using an agent executing 340 a model 342 including an artificial neural net trained using an actor-critic method, according to one example embodiment.

FIG. 8 is an illustration of a computer that can be used to control the machine for manipulating plants in the field, according to one example embodiment.

The figures depict embodiments for purposes of illustration only. One skilled in the art will readily recognize from the following description that alternative embodiments of the structures and methods illustrated herein may be employed without departing from the principles of the invention described herein.

### DETAILED DESCRIPTION

### I. Introduction

Farming machines that affect (manipulate) plants in a field have continued to improve over time. Farming machines can include a multitude of components for accomplishing the task of harvesting plants in a field. They can further include any number of sensors that take measurements to monitor the performance of a component, a group of components, or a state of a component. Traditionally, measurements are reported to the operator and the operator can manually make changes to the configuration of the components of the farming machine to improve the performance. However, as the complexity of the farming machines has increased, it has become increasingly difficult for an operator to understand how a single change in a component affects the overall performance of the farming machine. Similarly, classical optical control models that automatically adjust machine components are unviable because the various processes for accomplishing the machines task are nonlinear and highly complex such that the machines system dynamics are unknown.

Described herein is a farming machine that employs a machine learned model that automatically determines, in real-time, actions to affect components of the machine to improve performance of the machine. In one example, the machine learned model is trained using a reinforcement learning technique. Models trained using reinforcement learning excel at recognizing patterns in large interconnected data structures, herein applied to the measurements from a farming machine, without the input of an operator. The model can generate actions for the farming machine that are predicted to improve the performance of the machine based on those recognized patterns. Accordingly, a farming machine is described that executes a model trained using reinforcement learning and which allows the farming machine to operate more efficiently with less input from the operator. Among other benefits, this helps reduce operator fatigue and distraction, for example in the case where the operator is also driving the farming machine.

### II. Plant Manipulation Machine

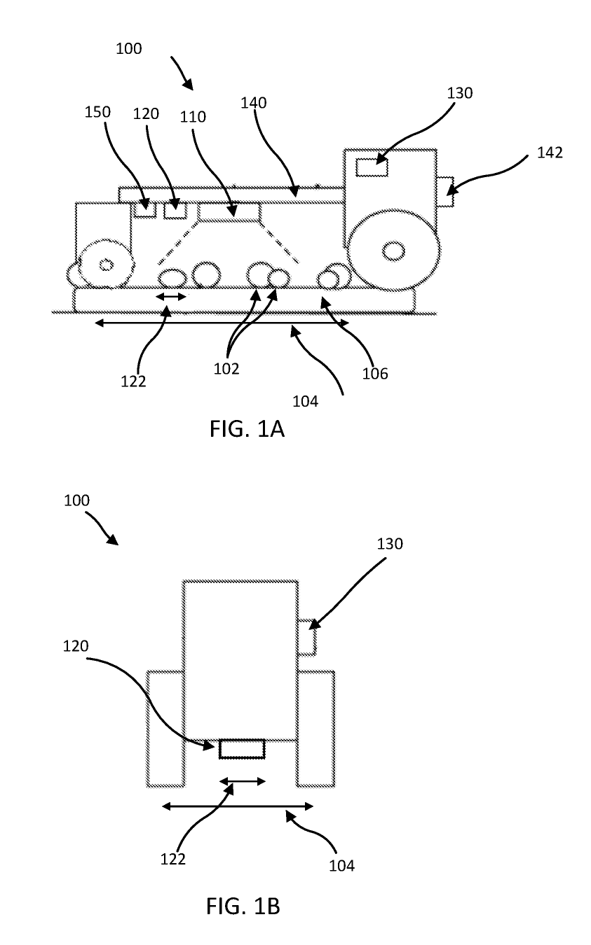

FIG. 1 is an illustration of a machine for manipulating plants in a field, according to one example embodiment. While the illustrated machine 100 is akin to a tractor pulling a farming implement, the system can be any sort of system for manipulating plants 102 in a field. For example, the system can be a combine harvester, a crop thinner, a seeder, a planter, a boom sprayer, etc. The machine 100 for plant manipulation can include any number of detection mechanisms 110, manipulation components 120 (components), and control systems 130. The machine 100 can additionally include any number of mounting mechanisms 140, verification systems 150, power sources, digital memory, communication apparatus, or any other suitable components.

The machine 100 functions to manipulate one or multiple plants 102 within a geographic area 104. In various configurations, the machine 100 manipulates the plants 102 to regulate growth, harvest some portion of the plant, treat a plant with a fluid, monitor the plant, terminate plant growth, remove a plant from the environment, or any other type of plant manipulation. Often, the machine 100 directly manipulates a single plant 102 with a component 120, but can also manipulate multiple plants 102, indirectly manipulate one or more plants 102 in proximity to the machine 100, etc. Additionally, the machine 100 can manipulate a portion of a single plant 102 rather than a whole plant 102. For example, in various embodiments, the machine 100 can prune a single leaf off of a large plant, or can remove an entire plant from the soil. In other configurations, the machine 100 can manipulate the environment of plants 102 with various components 120. For example, the machine 100 can remove soil to plant new plants within the geographic area 104, remove unwanted objects from the soil in the geographic area 104, etc.

The plants 102 can be crops, but can alternatively be weeds or any other suitable plant. The crop may be cotton, but can alternatively be lettuce, soy beans, rice, carrots, tomatoes, corn, broccoli, cabbage, potatoes, wheat or any other suitable commercial crop. The plant field in which the machine is used is an outdoor plant field, but can alternatively be plants 102 within a greenhouse, a laboratory, a grow house, a set of containers, a machine, or any other suitable environment. The plants 102 can be grown in one or more plant rows (e.g., plant beds), wherein the plant rows are parallel, but can alternatively be grown in a set of plant pots, wherein the plant pots can be ordered into rows or matrices or be randomly distributed, or be grown in any other suitable configuration. The plant rows are generally spaced between 2 inches and 45 inches apart (e.g. as determined from the longitudinal row axis), but can alternatively be spaced any suitable distance apart, or have variable spacing between multiple rows. In other configurations, the plants are not grown in rows.

The plants 102 within each plant field, plant row, or plant field subdivision generally includes the same type of crop (e.g. same genus, same species, etc.), but can alternatively include multiple crops or plants (e.g., a first and a second plant), both of which can be independently manipulated. Each plant 102 can include a stem, arranged superior (e.g., above) the substrate, which supports the branches, leaves, and fruits of the plant. Each plant 102 can additionally include a root system joined to the stem, located inferior the substrate plane (e.g., below ground), that supports the plant position and absorbs nutrients and water from the substrate 106. The plant can be a vascular plant, non-vascular plant, ligneous plant, herbaceous plant, or be any suitable type of plant. The plant can have a single stem, multiple stems, or any number of stems. The plant can have a tap root system or a fibrous root system. The substrate 106 is soil, but can alternatively be a sponge or any other suitable substrate. The components 120 of the machine 100 can manipulate any type of plant 102, any portion of the plant 102, or any portion of the substrate 106 independently.

The machine 100 includes multiple detection mechanisms 110 configured to image plants 102 in the field. In some configurations, the each detection mechanism 110 is configured to image a single row of plants 102 but can image any number of plants in the geographic area 104. The detection mechanisms 110 function to identify individual plants 102, or parts of plants 102, as the machine 100 travels through the geographic area 104. The detection mechanism 110 can also identify elements of the environment surrounding the plants 102 of elements in the geographic area 104. The detection mechanism 110 can be used to control any of the components 120 such that a component 120 manipulates an identified plant, part of a plant, or element of the environment. In various configurations, the detection system 110 can include any number of sensors that can take a measurement to identify a plant. The sensors can include a multispectral camera, a stereo camera, a CCD camera, a single lens camera, hyperspectral imaging system, LIDAR system (light detection and ranging system), dyanmometer, IR camera, thermal camera, or any other suitable detection mechanism.

Each detection mechanism 110 can be coupled to the machine 100 a distance away from a component 120. The detection mechanism 110 can be statically coupled to the machine 100 but can also be movably coupled (e.g., with a movable bracket) to the machine 100. Generally, machine 100 includes some detection mechanisms 110 that are positioned so as to capture data regarding a plant before the component 120 encounters the plant such that a plant can be identified before it is manipulated. In some configurations, the component 120 and detection mechanism 110 arranged such that the centerlines of the detection mechanism 110 (e.g. centerline of the field of view of the detection mechanism) and a component 120 are aligned, but can alternatively be arranged such that the centerlines are offset. Other detection mechanisms 110 may be arranged to observe the operation of one of the components 120 of the device, such as harvested grain passing into a plant storage component, or a harvested grain passing through a sorting component.

A component 120 of the machine 100 functions to manipulate plants 102 as the machine 100 travels through the geographic area. A component 120 of the machine 100 can, alternatively or additionally, function to affect the performance of the machine 100 even though it is not configured to manipulate a plant 102. In some examples, the component 120 includes an active area 122 to which the component 120 manipulates. The effect of the manipulation can include plant necrosis, plant growth stimulation, plant portion necrosis or removal, plant portion growth stimulation, or any other suitable manipulation. The manipulation can include plant 102 dislodgement from the substrate 106, severing the plant 102 (e.g., cutting), fertilizing the plant 102, watering the plant 102, injecting one or more working fluids into the substrate adjacent the plant 102 (e.g., within a threshold distance from the plant), harvesting a portion of the plant 102, or otherwise manipulating the plant 102.

Generally, each component 120 is controlled by an actuator. Each actuator is configured to position and activate each component 120 such that the component 120 manipulates a plant 102 when instructed. In various configurations, the actuator can position a component such that the active area 122 of the component 120 is aligned with a plant to be manipulated. Each actuator is communicatively coupled with an input controller that receives machine commands from the control system 130 instructing the component 120 to manipulate a plant 102. The component 120 is operable between a standby mode, where the component does not manipulate a plant 102 or affect machine 100 performance, and a manipulation mode, wherein the component 120 is controlled by the actuation controller to manipulate the plant or affects machine 100 performance. However, the component(s) 120 can be operable in any other suitable number of operation modes. Further, an operation mode can have any number of sub-modes configured to control manipulation of the plant 102 or affect performance of the machine.

The machine 100 can include a single component 120, or can include multiple components. The multiple components can be the same type of component, or be different types of components. In some configurations, a component can include any number of manipulation sub-components that, in aggregate, perform the function of a single component 120. For example, a component 120 configured to spray treatment fluid on a plant 102 can include sub-components such as a nozzle, a valve, a manifold, and a treatment fluid reservoir. The sub-components function together to spray treatment fluid on a plant 102 in the geographic area 104. In another example, a component 120 configured to move a plant 102 towards a storage component can include sub-components such as a motor, a conveyor, a container, and an elevator. The sub-components function together to move a plant towards a storage component of the machine 100.

In one example configuration, the machine 100 can additionally include a mounting mechanism 140 that functions to provide a mounting point for the various machine 100 elements. In one example, the mounting mechanism 140 statically retains and mechanically supports the positions of the detection mechanism(s) 110, component(s) 120, and verification system(s) 150 relative to a longitudinal axis of the mounting mechanism 140. The mounting mechanism 140 is a chassis or frame, but can alternatively be any other suitable mounting mechanism. In some configurations, there may be no mounting mechanism 140, or the mounting mechanism can be incorporated into any other component of the machine 100.

In one example machine 100, the system may also include a first set of coaxial wheels, each wheel of the set arranged along an opposing side of the mounting mechanism 140, and can additionally include a second set of coaxial wheels, wherein the rotational axis of the second set of wheels is parallel the rotational axis of the first set of wheels. However, the system can include any suitable number of wheels in any suitable configuration. The machine 100 may also include a coupling mechanism 142, such as a hitch, that functions to removably or statically couple to a drive mechanism, such as a tractor, more to the rear of the drive mechanism (such that the machine 100 is dragged behind the drive mechanism), but alternatively the front of the drive mechanism or to the side of the drive mechanism. Alternatively, the machine 100 can include the drive mechanism (e.g., a motor and drive train coupled to the first and/or second set of wheels). In other example systems, the system may have any other means of traversing through the field.

In some example systems, the detection mechanism 110 can be mounted to the mounting mechanism 140, such that the detection mechanism 110 traverses over a geographic location before the component 120 traverses over the geographic location. In one variation of the machine 100, the detection mechanism 110 is statically mounted to the mounting mechanism 140 proximal the component 120. In variants including a verification system 150, the verification system 150 is arranged distal to the detection mechanism 110, with the component 120 arranged there between, such that the verification system 150 traverses over the geographic location after component 120 traversal. However, the mounting mechanism 140 can retain the relative positions of the system components in any other suitable configuration. In other systems, the detection mechanism 110 can be incorporated into any other component of the machine 100.

The machine 100 can include a verification system 150 that functions to record a measurement of the system, the substrate, the geographic region, and/or the plants in the geographic area. The measurements are used to verify or determine the state of the system, the state of the environment, the state substrate, the geographic region, or the extent of plant manipulation by the machine 100. The verification system 150 can, in some configurations, record the measurements made by the verification system and/or access measurements previously made by the verification system 150. The verification system 150 can be used to empirically determine results of component 120 operation as the machine 100 manipulates plants 102. In other configurations, the verification system 150 can access measurements from the sensors and derive additional measurements from the data. In some configurations of the machine 100, the verification system 150 can be included in any other components of the system. The verification system 150 can be substantially similar to the detection mechanism 110, or be different from the detection mechanism 110.

In various configurations, the sensors of a verification system 150 can include a multispectral camera, a stereo camera, a CCD camera, a single lens camera, hyperspectral imaging system, LIDAR system (light detection and ranging system), dyanmometer, IR camera, thermal camera, humidity sensor, light sensor, temperature sensor, speed sensor, rpm sensor, pressure sensor, or any other suitable sensor.

In some configurations, the machine 100 can additionally include a power source, which functions to power the system components, including the detection mechanism 100, control system 130, and component 120. The power source can be mounted to the mounting mechanism 140, can be removably coupled to the mounting mechanism 140, or can be separate from the system (e.g., located on the drive mechanism). The power source can be a rechargeable power source (e.g., a set of rechargeable batteries), an energy harvesting power source (e.g., a solar system), a fuel consuming power source (e.g., a set of fuel cells or an internal combustion system), or any other suitable power source. In other configurations, the power source can be incorporated into any other component of the machine 100.

In some configurations, the machine 100 can additionally include a communication apparatus, which functions to communicate (e.g., send and/or receive) data between the control system 130, the identification system 110, the verification system 150, and the components 120. The communication apparatus can be a Wi-Fi communication system, a cellular communication system, a short-range communication system (e.g., Bluetooth, NFC, etc.), a wired communication system or any other suitable communication system.

### III. Combine

In one example embodiment, the machine 100 is an agricultural combine harvester (combine) that travels through a geographic area and harvests plants 102. The components 120 of the combine are configured to harvest a portion of a plant in the field as the machine 100 travels over the plants 102 in the geographic area 104. The combine includes various detection mechanisms 110 and verification systems 150 to monitor the harvesting performance of the combine as it travels through the geographic area. The harvesting performance can be quantified by the control system 130 using any of the measurements from the various sensors of the machine 100. In various configurations, the performance can be based on metrics including amount of plant harvested, threshing quality of the plant, cleanliness of the harvested grain, throughput of the combine, and plant loss of the combine.

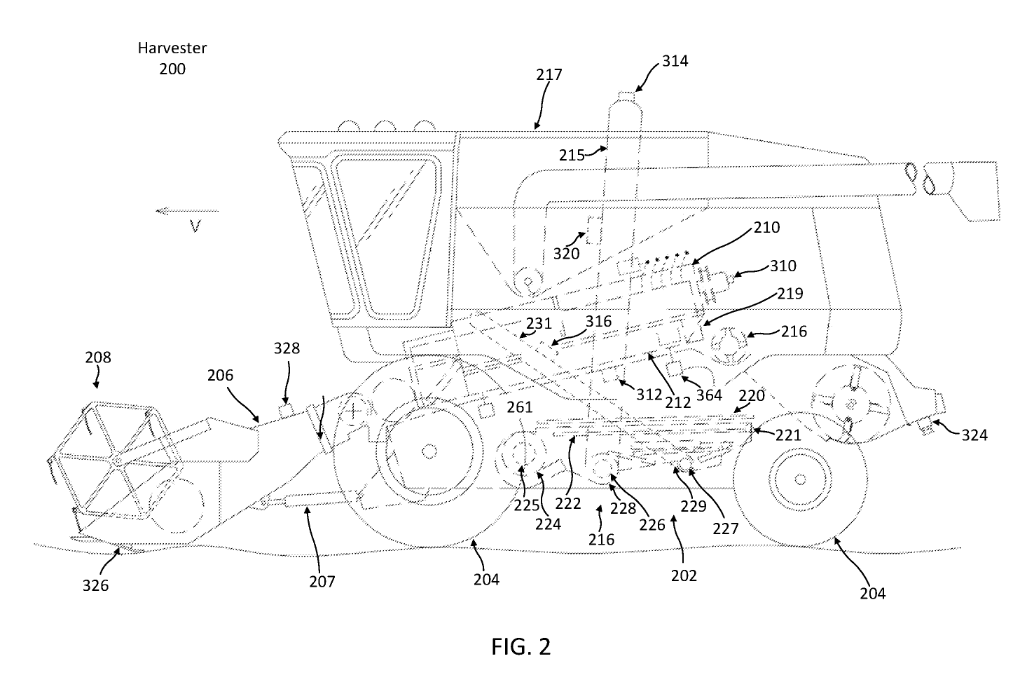

FIG. 2 is an example combine 200, here shown as a harvester, illustrating the combines 200 components 120, verification system 110, and verification system 150, according to one example embodiment. The combine 200 comprises a chassis 202 that is supported on wheels 204 to be driven over the ground and harvest crops (a plant 102). The wheels 204 may engage the ground directly or they may drive endless tracks. A feederhouse 206 extends from the front of the agricultural combine 200. Feederhouse lift cylinders 207 extend between the chassis of the agricultural combine 200 and the feederhouse to raise and lower the feederhouse (and hence the agricultural harvesting head 208) with respect to the ground. An agricultural harvesting head 208 is supported on the front of the feederhouse 206. When the agricultural combine 200 operates, it carries the feederhouse 206 through the field harvesting crops. The feederhouse 206 conveys crop gathered by the agricultural harvesting head 208 rearward and into the body of the agricultural combine 200.

Once inside the agricultural combine 200, the crop is conveyed into separator which comprises a rotor 210 that is cylindrical and a threshing bucket or threshing basket 212. A threshing basket 212 surrounds the rotor 210 and is stationary. The rotor 210 is driven in rotation by a controllable internal combustion engine 214. In some configurations, the rotor 210 includes a separator vane which includes a series of extensions into the rotor 210 drum that guide the crop material from front of the rotor 210 to the back of the rotor 210 as the rotor 210 rotates. The separator vanes are angled with respect to the crop flow into the rotor at a vane angle. The separator vane angle is controllable by an actuator. The vane angle can affect the amount and quality of grain reaching the threshing basket 212. The threshing basket 112 surrounds the rotor 110 and is stationary. Crop material is conveyed into the gap between the rotor 110 and the threshing basket 112 and is threshed and separated into a grain component and a MOG (material other than grain) component. The distance between the rotor 210 and the threshing basket 212 (threshing gap distance) is controllable by an actuator. The threshing gap distance clearance can affect the quality of the harvested plant. That is, changing the threshing gap distance can change the relative amounts of unthreshed plant, material other than grain, and usable grain that is processed by the machine 100.

The MOG is carried rearward and released from between the rotor 210 and the threshing basket 212. It then is received by a re-thresher 216 where the remaining kernels of grain are released. The now-separated MOG is released behind the vehicle to fall upon the ground.

Most of the grain separated in the separator (and some of the MOG) falls downward through apertures in the threshing basket 212. From there it falls into a cleaning shoe 218.

The cleaning shoe 218 has two sieves: an upper sieve 220, and a lower sieve 222. Each sieve includes a sieve separation that allows grain and MOG to fall downward and the sieve separation is controllable by an actuator. The sieve separation can affect the quality and type of grains falling towards the cleaning shoe 218. A fan 224 that is controllable by an actuator is provided at the front of the cleaning shoe to blow air rearward underneath the sieves. This air passes upward through the sieves and lifts chaff, husks, culm and other small particles of MOG (as well as a small portion of grain). The air carries this material rearward to the rear end of the sieves. A motor 225 drives the fan 224.

Most of the grain entering the cleaning shoe 218, however, is not carried rearward, but passes downward through the upper sieve 220, then through the lower sieve 222.

Of the material carried by air from the fan 224 to the rear of the sieves, smaller MOG particles are blown out of the rear of the combine. Larger MOG particles and grain are not blown off the rear of the combine, but fall off the cleaning shoe 218 and onto a shoe loss sensor 221 located on the left side of the cleaning shoe 218, and which is configured to detect shoe losses on the left side of the cleaning shoe 218, and on a shoe loss sensor 223 located on the right side of the cleaning shoe 218 and which is configured to detect shoe losses on the right side of the cleaning shoe 218. The shoe loss sensor 223 can provide a signal that is indicative of the quantity of material (which may include grain and MOG mixed together) carried to the rear of the cleaning shoe when falling off the right side of the cleaning shoe 218.

Heavier material that is carried to the rear of the upper sieve 220 and the lower sieve 222 falls onto a pan and is then conveyed by gravity downward into an auger trough 227. This heavier material is called “tailings” and is typically a mixture of grain and MOG.

The grain that passes through the upper sieve 220 and the lower sieve 222 falls downward into an auger trough 226. Generally, the upper sieve 220 has a larger sieve separation than the lower sieve 222 such that upper sieve 220 filters out larger MOG and the lower sieve 222 filters out smaller MOG. Generally, the material that passes through the two sieves has a higher proportion of clean grain compared to MOG. A clean grain auger 228 disposed in the auger trough 226 carries the material to the right side of the agricultural combine 200 and deposits the grain in the lower end of the grain elevator 215. The grain lifted by the grain elevator 215 is carried upward until it reaches the upper exit of the grain elevator 215. The grain is then released from the grain elevator 215 and falls into a grain tank 217. Grain entering the grain tank 216 can be measured for various characteristics including: amount, mass, volume, cleanliness (amount of MOG), and quality (amount of usable grain).

### III. Control System Network

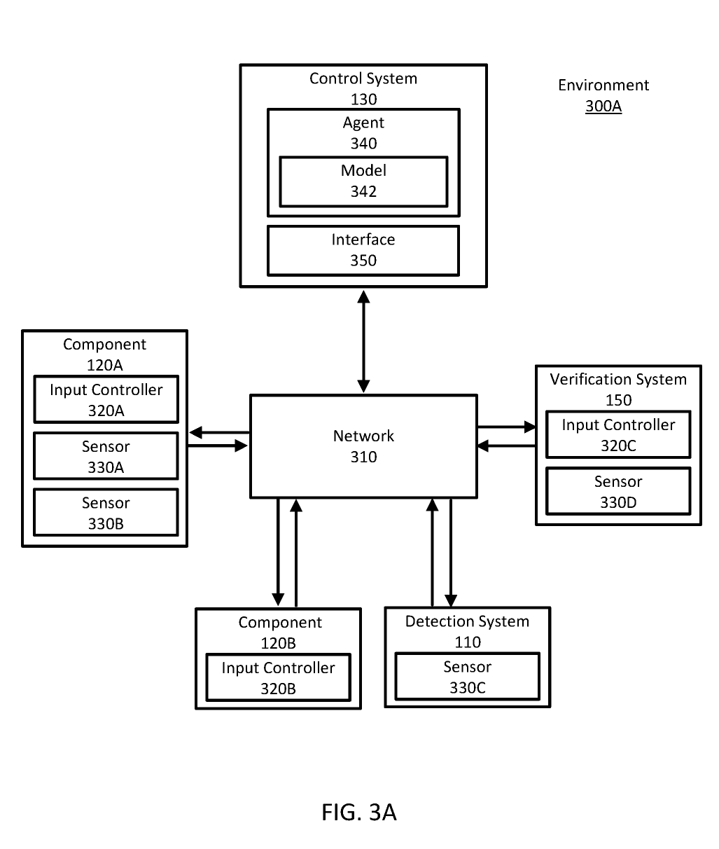

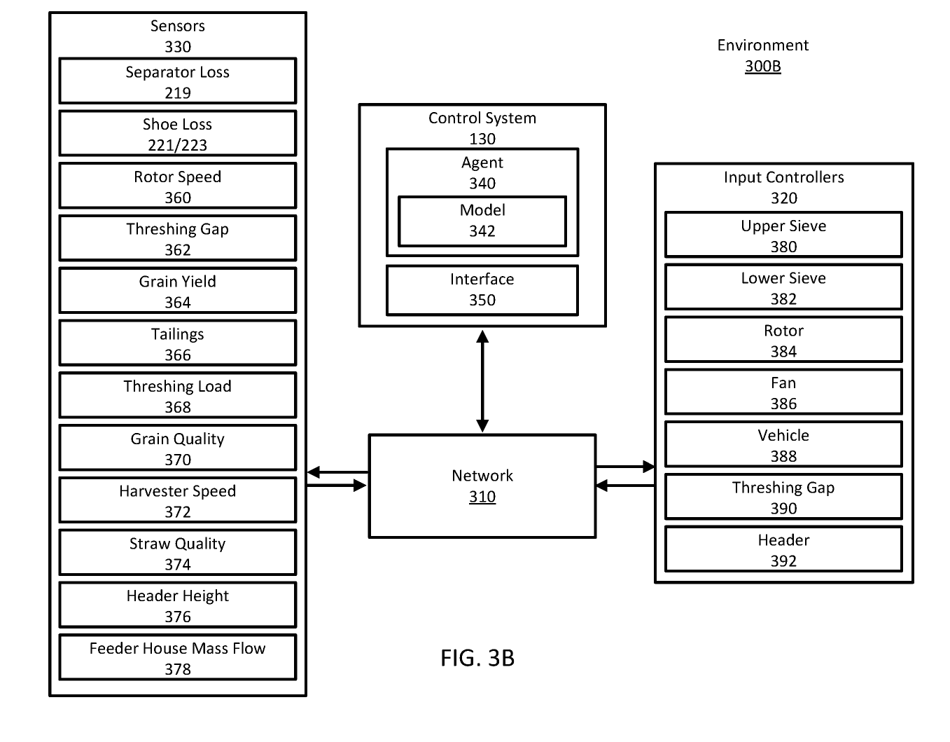

FIGS. 3A and 3B are high-level illustrations of a network environment 300, according to one example embodiment. The machine 100 includes a network digital data environment that connects the control system 130, detection system 110, the components 120, and the verification system 150 via a network 310.

Various elements connected within of the environment 300 include any number of input controllers 320 and sensors 330 to receive and generate data within the environment 300. The input controllers 320 are configured to receive data via the network 310 (e.g., from other sensors 330 such as those associated with the detection system 110) or from their associated sensors 330 and control (e.g., actuate) their associated component 120 or their associated sensors 330. Broadly, sensors 330 are configured to generate data (i.e., measurements) representing a configuration or capability of the machine 100. A “capability” of the machine 100, as referred to herein, is, in broad terms, a result of a component 120 action as the machine 100 manipulates plants 102 (takes actions) in a geographic area 104. Additionally, a “configuration” of the machine 100, as referred to herein, is, in broad terms, a current speed, position, setting, actuation level, angle, etc., of a component 120 as the machine 100 takes actions. A measurement of the configuration and/or capability of a component 120 or the machine 100 can be, more generally and as referred to herein, a measurement of the “state” of the machine 100. That is, various sensors 330 can monitor the components 120, the geographic area 104, the plants 102, the state of the machine 100, or any other aspect of the machine 100.

An agent 340 executing on the control system 130 inputs the measurements received from via the network 330 into a control model 342 as a state vector. Elements of the state vector can include numerical representations of the capabilities or states of the system generated from the measurements. The control model 342 generates an action vector for the machine 100 predicted by the model 342 to improve machine 100 performance. Each element of the action vector can be a numerical representation of an action the system can take to manipulate a plant, manipulate the environment, or otherwise affect the performance of the machine 100. The control system 130 sends machine commands to input controllers 320 based on the elements of the action vectors. The input controllers receive the machine commands and actuate their component 120 to take an action. Generally, the action leads to an increase in machine 100 performance.

In some configurations, control system 130 can include an interface 350. The interface 350 allows a user to interact with the control system 130 and control various aspects of the machine 100. Generally the interface 350 includes an input device and a display device. The input device, can be one or more of a keyboard, button, touchscreen, lever, handle, knob, dial, potentiometer, variable resistor, shaft encoder, or other device or combination of devices that are configured to receive inputs from a user of the system. The display device can be a CRT, LCD, plasma display, or other display technology or combination of display technologies configured to provide information about the system to a user of the system. The interface can be used to control various aspects of the agent 340 and model 342.

The network 310 can be any system capable of communicating data and information between elements within the environment 300. In various configurations, the network 310 is a wired network, a wireless network, or a mixed wired and wireless network. In one example embodiment, the network is a controller area network (CAN) and the elements within the environment 300 communicate with each other over a CAN bus.

III.A Example Control System Network

Again referring to FIG. 3A, FIG. 3A illustrates an example embodiment of the environment 300A for a machine 100. In this example, the control system 130 is connected to a first component 120A and a second component 120B. The first component 120A includes an input controller 320A, a first sensor 330A, and a second sensor 330B. The input controller 320A receives machine commands from the network system 310 and actuates the component 120A in response. The first sensor 330A generates measurements representing a first state of the component 120A and the second sensor 330B generates measurements representing a configuration of the first component 120A when manipulating plants. The second component 120B includes an input controller 320B. The control system 130 is connected a detection system 110 including a sensor 330C configured to generate measurements for identifying plants 102. Finally, the control system 130 is connected to a verification system 150 that includes an input controller 320C and a sensor 330D. In this case, the input controller 320C receives machine commands that controls the position and sensing capabilities of the sensor 330D. The sensor 330D is configured to generate data representing the capability of component 120B that affects the performance of the machine 100.

In various other configurations, the machine 100 can include any number of detection systems 110, components 120, verifications systems 150, and/or networks 310. Accordingly, the environment 300A can be configured in a manner other than that illustrated in FIG. 3A. For example, the environment 300 can include any number of components 120, verification systems 150, and detection systems 110 with each element including various combinations of input controllers 320, and/or sensors 330.

III.B Harvester Control System Network

FIG. 3B is a high-level illustration of a network environment 300B of the combine 200 illustrated in FIG. 2, according to one example embodiment. In this illustration, for clarity, elements of the environment 300B are grouped as input controllers 320 and sensors 330 rather than as their constituent elements (component 120, verification system 150, etc.).

The sensors 330 include a separator loss sensor 219, a shoe loss sensor 221/223, a rotor speed sensor 360, a threshing gap sensor 362, a grain yield sensor 364, a tailings sensor 366, a threshing load sensor 368, grain quality sensor 370, straw quality sensor 374, header height sensor 376, and feederhouse mass flow sensor 378, but can include any other sensor 330 that can determine a state of the combine 200.

The separator loss sensor 219 can provide a measurement of the quantity of grain that was carried to the rear of the separator. In one configuration, the separator loss sensor 219 is located at the end of the rotor 210 and the threshing basket 212. In one configuration, the separator loss sensor can additionally include a threshing loss sensor. The threshing loss sensor can provide a measurement of the quantity of grain that is lost after threshing. In one configuration the threshing loss sensor is located proximally to the threshing basket 212.

The shoe loss sensors 221 and 223 can provide a measurement representing the quantity of material (which may include grain and MOG mixed together) carried to the rear of the cleaning shoe and falling off the sides (left and right, respectively) of the cleaning shoe 218. The shoe loss sensors are located at the end of the shoe.

The rotor speed sensor 360 can provide a measurement representing the speed of the rotor 210. The faster the rotor 210 rotates, the more quickly it threshes crop. At the same time, as the rotor turns faster, it damages a larger proportion of the grain. Thus, by varying the rotor speed, the proportion of grain threshed and proportion of damaged grain can change. In one configuration, the rotor speed sensor 360 can be a shaft speed sensor and measure the speed of the rotor 210 directly.

In another configuration, the rotor speed sensor 360 can be combination of other sensors that cumulatively provide a measurement representing the speed of the rotor 210. For example, sensors including a hydraulic fluid flow rate sensor for fluid flow through a hydraulic motor that drives the rotor 210, or an internal combustion engine 214 speed sensor in conjunction with another a measurement that indicates a selected gear ratio of a gear train between the internal combustion engine 214 and the rotor 210, or a swash plate position sensor and shaft speed sensor of a hydraulic motor that can provide hydraulic fluid to a hydraulic motor driving the rotor 210

The threshing gap sensor 362 can provide a measurement representing a gap between the rotor 210 and the threshing basket 212. As the gap is reduced, the plant is threshed more vigorously, reducing the separator loss. At the same time, a reduced gap produces greater damage to grain. Thus, by changing the threshing gap the separator loss and the amount of grain damaged can be changed. In another configuration, the threshing gap sensor 362 additionally includes a separator vane sensor. The separator vane sensor can provide a measurement representing the vane angle. The vane can increase or reduce the amount of plant being threshed and can, accordingly, reduce separator loss. At the same time, the vane angle can produce greater damage to grain. Thus, by changing the vane angle the separator loss and the amount of grain damaged can be changed

The grain yield sensor 364 can provide a measurement representing a flow rate of clean grain. The grain yield sensor, can include an impact sensor that is located adjacent to an outlet of the grain elevator 215 where the grain enters the grain tank 217. In this configuration, grain carried upward in the grain elevator 215 impacts the grain yield sensor 364 with the force equivalent to the mass flow rate of grain into the grain tank. In another configuration, the grain yield sensor 364 is coupled to a motor (not shown) driving the grain elevator 215 and can provide a measurement representing the load on the motor. The load on the motor represents the quantity of grain carried upward by the grain elevator 215. In another configuration, the load on the motor can be determined by measuring the current through and/or voltage across the motor (in the case of an electric motor). In another configuration, the motor can be a hydraulic motor, and a load of the motor can be determined by measuring the fluid flow rate to the motor and/or the hydraulic pressure across the motor.

The tailings sensor 366 and the grain quality sensor 370 can each provide a measurement representing the quality of the grain. The measurement may be one or more of the following: a measurement representing an amount or proportion of usable grain, a measurement representing the amount or proportion of damaged grain (e.g. cracked or broken kernels of grain), a measurement representing the amount or proportion of MOG mixed with the grain (which can be further characterized as an amount or proportion of different types of MOG, such as light MOG or heavy MOG), and the a measurement representing the an amount or proportion of unthreshed grain.

In one configuration, the grain quality sensor 370 is located in a grain flow path between the clean grain auger 228 and the grain tank 217. That is, the grain quality sensor 370 is located adjacent to the grain elevator 215, and, more particularly, the grain quality sensor 370 is located to receive samples of grain from the grain elevator 215 and to sense characteristics of grain sampled from the grain elevator 215.

In one configuration, the tailings sensor 366 is located in a grain flow path between the tailings auger 229 and the forward end of the rotor 210 where the tailings are released from the tailings elevator 231 and are deposited between the rotor 210 and the threshing basket 212 for re-threshing. That is, the tailings sensor 366 is located adjacent to the tailings elevator 231, and, more particularly, the tailings sensor 366 is located to receive samples of grain from the tailings elevator 231 and to sense characteristics of grain from the tailing elevator 231.

The threshing load sensor 368 can provide a measurement representing the threshing load (i.e., the load applied to the rotor 210). In one configuration, the threshing load sensor 368 comprises a hydraulic pressure sensor disposed to sense the pressure in a motor driving the rotor 210. In another configuration, (in the case of a rotor 210 that is driven by a belt and sheave), the threshing load sensor 368 includes a sensor configured to sense the hydraulic pressure applied to a variable diameter sheave at a rear end of the rotor 210 and by which the rotor 210 is coupled to and driven by a drive belt. In another configuration, the threshing load sensor 368 can include a torque sensor configured to sense a torque in a shaft driving the rotor 210.

In one configuration, the tailings sensor 366 and the grain quality sensor 370 each include a digital camera configured to capture an image of a grain sample. In this case, the control system 130 or tailings sensor 366 can be configured to interpret the captured image and determine the quality of the grain sample.

The straw quality sensor 374 can provide at least one a measurement representing the quality of straw (e.g. MOG) leaving the combine 200. “Quality of straw” represents a physical characteristic (or characteristics) of the straw and/or straw windrows that accumulate behind the combine 200. In certain regions of the world, straw, typically gathered in windrows is later gathered and either sold or used. The dimensions (length, width, and height) of the straw and/or straw windows can be a factor in determining its value. For example, short straw is particularly valuable for use as animal feed. Long straw is particularly valuable for use as animal bedding. Long straw permits tall, open, airy windrows to be formed. These windrows dry faster in the field and (due to their height above the ground) are lifted up by balers with less entrained dirt and other contaminants from the ground.

In one configuration, the straw quality sensor 374 comprises a camera directed towards the rear of the combine to take a picture of the straw as it exits the combine and is suspended in the air falling toward the ground or to take a picture of the windrow as it is created by the falling straw. In this configuration, the straw quality sensor 374 or control system 130 can be configured to access or receive the image from the camera, process it, and characterize the straw length or characterize the dimensions of the windrow created by the straw on the ground behind the combine 200. In another configuration, the straw quality sensor 374 comprises a range detector, such as a laser scanner or ultrasonic sensor directed toward the straw that can determine the dimensions of the straw and/or straw windows.

The header height sensor 376 can provide a measurement representing the height of the agricultural harvesting head 208 with respect to the ground. In one configuration, the header height sensor 376 comprises a rotary sensor element such as a shaft encoder, potentiometer, or a variable resistor to which is coupled an elongate arm. The remote end of the arm drags over the ground, and as the agricultural harvesting head 208 changes in height, the arm changes its angle and rotates the rotary sensor element. In another configuration, the header height sensor 376 comprises an ultrasonic or laser rangefinder.

The feederhouse mass flow sensor 378 can provide a measurement representing the thickness of the crop mat that is drawn into the feederhouse and into the agricultural combine 200 itself. Generally, a correlation exists between crop mass and crop yield (i.e. grain yield). The control system 130 can be configured to calculate the grain yield by combining a measurement from the header height sensor 376 and the a measurement from the feederhouse mass flow sensor 378 together with agronomic tables stored in memory circuits of the control system 130. This configuration can be used in addition to, or alternatively to a measurement from the grain yield sensor 364 to provide a measurement representing the flow rate of clean grain.

The combine speed sensor 372 is any combination of sensors that can provide a measurement representing the speed of the combine in the geographic area 104. The speed sensors can include GPS sensors, engine load sensors, accelerometers, gyroscopes, gear sensors, or any other sensors or combination of sensors that can determine velocity.

The input controllers 340 include an upper sieve controller 380, a lower sieve controller 382, a rotor speed controller 384, a fan speed controller 386, a vehicle speed controller 388, a threshing gap controller 390, and a header height controller 392, but can include any other input controller that can control a component 120, identification system 110, or verification system 150. Each of the input controllers 340 is communicatively coupled to an actuator that can actuate its coupled element. Generally, the input controller can receive machine commands from the control system 130 and actuate a component 120 with the actuator in response.

The upper sieve controller 380 is coupled to the upper sieve 220 and is configured to change the angle of individual sieve elements (slats) that comprise the upper sieve 220. By changing the position (angle) of the individual sieve elements, the amount of air that passes through the upper sieve 220 can be varied to increase or decrease (as desired) the vigor with which the grain is sieved.

The lower sieve controller 382 is coupled to the lower sieve 222 and is configured to change the angle of individual sieve elements (slats) that comprise the lower sieve 222. By changing the position (angle) of the individual sieve elements, the amount of air that passes through the lower sieve 222 can be varied to increase or decrease (as desired) the vigor with which the grain is sieved.

The rotor speed controller 384 is coupled to variable drive elements located between the internal combustion engine 214 and the rotor 210. These variable drive elements can include gearboxes, gear sets, hydraulic pumps, hydraulic motors, electric generators, electric motors, sheaves with a variable working diameter, belts, shafts, belt variators, IVTs, CVTs, and the like (as well as combinations thereof). The rotor speed controller 384 controls the variable drive elements and are configured to vary the speed of the rotor 210.

The fan speed controller 386 is coupled to variable drive elements disposed between the internal combustion engine 214 and the fan 224 to drive the fan 224. These variable drive elements can include gearboxes, gear sets, hydraulic pumps, hydraulic motors, electric generators, electric motors, sheaves with a variable working diameter belts shafts, belt variators, IVT's, CVT's and the like (as ˜ell a˜ combinations thereof). The fan speed controller 386 is configured to control the variable drive elements to vary the speed of the fan 224. These variable drive elements are shown symbolically in FIG. 1 as motor 225.

The vehicle speed controller 388 is coupled to variable drive elements located between the internal combustion engine 214 and one or more of the wheels 204. These variable drive elements can include hydraulic or electric motors coupled to the wheels 204 to drive the wheels 204 in rotation. The vehicle speed controller 388 is configured to controls the variable drive elements, which in turn control the speed of the wheels 204 by varying a hydraulic or electrical flow through the motors that drive the wheels 204 in rotation and/or by varying a gear ratio of the gearbox coupled between the motors and the wheels 204. The wheels 204 may rest directly on the ground, or they may rest upon a recirculating endless track or belt which is disposed between the wheels and the ground.

The threshing gap controller 390 is coupled to one or more threshing gap actuators 391, 394 that are coupled to the threshing basket 212. The threshing gap controller is configured to change the gap between the rotor 210 and the threshing basket 212. Alternatively, the threshing gap actuators 391 are coupled to the threshing basket 212 to change the position of the threshing basket 212 with respect to the rotor 210. The actuators may comprise hydraulic or electric motors of the rotary-acting or linear-acting varieties.

The header height controller 392 is coupled to valves (not shown) that control the flow of hydraulic fluid to and from the feederhouse lift cylinders 207. The header height controller 392 is configured control the feederhouse by selectively raising and lowering the feederhouse and, accordingly, the agricultural harvesting head 208.

### IV. Control System Agent

As described above, the control system 130 executes an agent 340 that can control the various components 120 of machine 100 in real time and functions to improve the performance of that machine 100. Generally, the agent 340 is any program or method that can receive measurements from sensors 340 of the machine 100 and generate machine commands for the input controllers 330 coupled to the components 120 of the machine 100. The generated machine commands cause the input controllers 330 to actuate components 120 and change their state and, accordingly, change their performance. The changed state of the components 120 improves the overall performance of the machine 100.

In one embodiment, the agent 340 executing on the control system 130 can be described as executing the following function:

a= [symbol] (s) (4.1)

where s is an input state vector, the a is an output action vector, and the function F is a machine learning model that functions to generate output action vectors that improve the performance of the machine 100 given input state vectors.

Generally, the input state vector s is a representation of the measurements received from sensors 320 of the machine 100. In some cases, the elements of the input state vector s are the measurements themselves, while in other cases, the control system 130 determines an input state vector s from the measurements M using an input function I such as:

s= [symbol] (m) (4.2)

where the input function I can be any function that can convert measurements from the machine 100 into elements of an input function I. In some cases, the input function can calculate differences between an input state vector and a previous input state vector (e.g., at an earlier time step). In other cases, the input function can manipulate the input state vector such that it is compatible with the function F (e.g., removing errors, ensuring elements are within bounds, etc.).

Additionally, the output action vector a is a representation of the machine commands c that can be transmitted to input controllers 320 of the machine 100. In some cases, the elements of the output action vector a are machine commands, while in other cases, the control system 130 determines machine commands from the output action vector a using an output function O:

c= [symbol] (a) (4.3)

where the output function O can be any function that can convert the output action vector into machine commands for the input controllers 320. In some examples the output function can function to ensure that the generated machine commands are within tolerances of their respective components 120 (e.g., not rotating too fast, not opening too wide, etc.).

In various other configurations, the machine learning model can use any function or method to model the unknown dynamics of the machine 100. In this case, the agent 340 can use a dynamic model 342 to dynamically generate machine commands for controlling the machine 100 and improve machine 100 performance. In various configurations the model can be any of: function approximators, probabilistic dynamics models such as Gaussian processes, neural networks, any other similar model. In various configurations, the agent 340 and model 342 can be trained using any of: Q-learning methods, state-action-state-reward methods, deep Q network methods, actor-critic methods, or any other method of training an agent 340 and model 342 such that the agent 340 can control the machine 100 based on the model 442.

In the example where the machine 100 is a combine 200, the performance can be represented by any of a set of metrics including one or more of: a measure of amount of plant harvested, threshing quality of the plant, cleanliness of the harvested grain, throughput of the combine, and plant loss of the combine. The amount of plant harvested can be the amount of grain entering the grain tank 217, the threshing quality can be the amount, quality, or loss of the plant after threshing in the threshing basket 212, the cleanliness of the harvested grain can be the quality of the plant entering the grain tank, the throughput of the combine can be the amount of grain entering the grain tank 217 over a period of time, and the grain loss can be the amount of grain lost at various stages of harvesting. As described previously, the performance can be determined by the control system 130 using measurements from any of the sensors 330 of the combine. Therefore, improving machine 100 performance can, in specific embodiments of the invention, include improving any one or more of these metrics, as determined by the receipt of improved measurements from the machine 100 with respect to any one or more of these metrics.

### V Reinforcement Learning

In one embodiment, the agent 340 can execute a model 342 including deterministic methods that has been trained with reinforcement learning (thereby creating a reinforcement learning model). The model 342 is trained to increase the machine 100 performance using measurements from sensors 330 as inputs, and machine commands for input controllers 320 as outputs.

Reinforcement learning is a machine learning system in which a machine learns ‘what to do’—how to map situations to actions—so as to maximize a numerical reward signal. The learner (e.g. the machine 100) is not told which actions to take (e.g., generating machine commands for input controllers 320 of components 120), but instead discovers which actions yield the most reward (e.g., increasing the quality of grain harvested) by trying them. In some cases, actions may affect not only the immediate reward but also the next situation and, through that, all subsequent rewards. These two characteristics—trial-and-error search and delayed reward—are two distinguishing features of reinforcement learning.

Reinforcement learning is defined not by characterizing learning methods, but by characterizing a learning problem. Basically, a reinforcement learning system captures those important aspects of the problem facing a learning agent interacting with its environment to achieve a goal. That is, in the example of a combine, the reinforcement learning system captures the system dynamics of the combine 200 as it harvests plants in a field. Such an agent senses the state of the environment and takes actions that affect the state to achieve a goal or goals. In its most basic form, the formulation of reinforcement learning includes three aspects for the learner: sensation, action, and goal. Continuing with the combine 200 example, the combine 200 senses the state of the environment with sensors, takes actions in that environment with machine commands, and achieves a goal that is a measure of the combine performance in harvesting grain crops.

One of the challenges that arises in reinforcement learning is the trade-off between exploration and exploitation. To increase the reward in the system, a reinforcement learning agent prefers actions that it has tried in the past and found to be effective in producing reward. However, to discover actions that produce reward, the learning agent selects actions that it has not selected before. The agent ‘exploits’ information that it already knows in order to obtain a reward, but it also ‘explores’ information in order to make better action selections in the future. The learning agent tries a variety of actions and progressively favors those that appear to be best while still attempting new actions. On a stochastic task, each action is generally tried many times to gain a reliable estimate to its expected reward. For example, if the combine is executing an agent that knows a particular combine speed leads to good system performance, the agent may change the combine speed with a machine command to see if the change in speed influences system performance.

Further, reinforcement learning considers the whole problem of a goal-directed agent interacting with an uncertain environment. Reinforcement learning agents have explicit goals, can sense aspects of their environments, and can choose actions to receive high rewards (i.e., increase system performance). Moreover, agents generally operate despite significant uncertainty about the environment it faces. When reinforcement learning involves planning, the system addresses the interplay between planning and real-time action selection, as well as the question of how environmental elements are acquired and improved. For reinforcement learning to make progress, important sub problems have to be isolated and studied, the sub problems playing clear roles in complete, interactive, goal-seeking agents.

V.A the Agent-Environment Interface

The reinforcement learning problem is a framing of a machine learning problem where interactions are processed and actions are carried out to achieve a goal. The learner and decision-maker is called the agent (e.g., agent 340 of combine 200). The thing it interacts with, comprising everything outside the agent, is called the environment (e.g., environment 300, plants 102, the geographic area 104, dynamics of the combine harvester process, etc.). These two interact continually, the agent selecting actions (e.g., machine commands for input controllers 320) and the environment responding to those actions and presenting new situations to the agent. The environment also gives rise to rewards, special numerical values that the agent tries to maximize over time. In one context, the rewards act to maximize system performance over time. A complete specification of an environment defines a task which is one instance of the reinforcement learning problem.

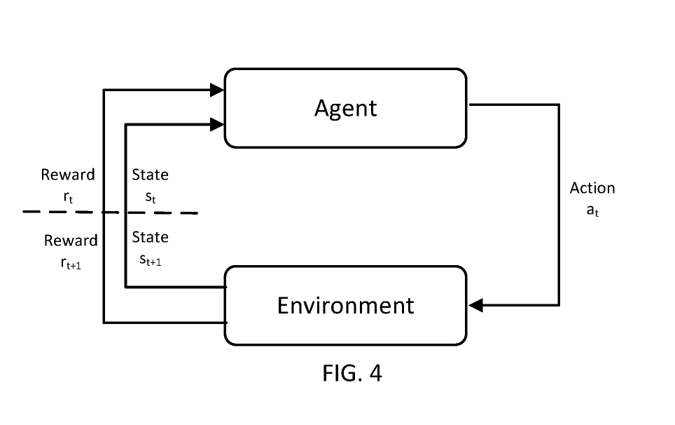

FIG. 4 diagrams the agent-environment interaction. More specifically, the agent (e.g., agent 340 of combine 200) and environment interact at each of a sequence of discrete time steps, i.e. t=0, 1, 2, 3, etc. At each time step t the agent receives some representation of the environment's state sₜ (e.g., measurements from sensor representing a state of the machine 100). The states sₜ are within S, where S is the set of possible states. Based on the state sₜ and the time step t, the agent selects an action at (e.g., a set of machine commands to change a configuration of a component 120). The action at is within A(sₜ), where A(sₜ) is the set of possible actions. One time state later, in part as a consequence of its action, the agent receives a numerical reward rₜ₊₁. The states rₜ₊₁ are within R, where R is the set of possible rewards. Once the agent receives the reward, the agent selects in a new state sₜ₊₁.

At each time step, the agent implements a mapping from states to probabilities of selecting each possible action. This mapping is called the agent's policy and is denoted πₜ where πₜ(s,a) is the probability that aₜ=a if sₜ=s. Reinforcement learning methods can dictate how the agent changes its policy as a result of the states and rewards resulting from agent actions. The agent's goal is to maximize the total amount of reward it receives over time.

This reinforcement learning framework is flexible and can be applied to many different problems in many different ways (e.g. to agriculture machines operating in a field). The framework proposes that whatever the details of the sensory, memory, and control apparatus, any problem (or objective) of learning goal-directed behavior can be reduced to three signals passing back and forth between an agent and its environment: one signal to represent the choices made by the agent (the actions), one signal to represent the basis on which the choices are made (the states), and one signal to define the agent's goal (the rewards).

Continuing, the time steps between actions and state measurements need not refer to fixed intervals of real time; they can refer to arbitrary successive stages of decision-making and acting. The actions can be low-level controls, such as the voltages applied to the motors of a combine, or high-level decisions, such as whether or not to plant a seed with a planter. Similarly, the states can take a wide variety of forms. They can be completely determined by low-level sensations, such as direct sensor readings, or they can be more high-level, such as symbolic descriptions of the soil quality. States can be based on previous sensations or even be subjective. Similarly, actions can be based previous actions, policies, or can be subjective. In general, actions can be any decisions the agent learns how to make to achieve a reward, and the states can be anything the agent can know that might be useful in selecting those actions.

Additionally, the boundary between the agent and the environment is generally not solely physical. For example, certain aspects of agricultural machinery, for example sensors 330, or the field in which it operates, can be considered parts of the environment rather than parts of the agent. Generally, anything that cannot be changed by the agent at the agent's discretion is considered to be outside of the agent and part of the environment. The agent-environment boundary represents the limit of the agent's absolute control, not of the agent's knowledge. As an example, the size of a tire of an agricultural machine can be part of the environment as it cannot be changed by the agent, but the angle of rotation of an axle on which the tire resides can be part of the agent as it is changeable, in this case controllable by actuation of the drivetrain of the machine. Additionally, the dampness of the soil in which the agricultural machine operates can be part of the environment, particularly if it is measured before an agricultural machine passes over it; however, the dampness or moisture of the soil can also be a part of the agent if the agricultural machine is configured to measure dampness/moisture after passing over that part of the soil and after applying water or another liquid to the soil. Similarly, rewards are computed inside the physical entity of the agricultural machine and artificial learning system, but are considered external to the agent.

The agent-environment boundary can be located at different places for different purposes. In an agricultural machine, many different agents may be operating at once, each with its own boundary. For example, one agent may make high-level decisions (e.g. increase the seed planting depth) which form part of the states faced by a lower-level agent (e.g. the agent controlling air pressure in the seeder) that implements the high-level decisions. In practice, the agent-environment boundary can be determined based on states, actions, and rewards, and can be associated with a specific decision-making task of interest.

Particular states and actions vary greatly from application to application, and how they are represented can strongly affect the performance of the implemented reinforcement learning system.

### VI Reinforcement Learning Methods

Within this section a variety of methodologies used for reinforcement learning are described. Any aspect of any of these methodologies can be applied to a reinforcement learning system within an agricultural machine operating in a field. Generally, the agent is the machine operating in the field and the environment are elements of the machine and the field not under direct control of the machine. States are measurements of the environment and how the machine is interacting within it, actions are decisions and actions taken by the agent to affect states, and results are a numerical representation to improvements (or decreases) of states.

VI.A Action-Value and State-Value Functions

Reinforcement learning models can be based on estimating state-value functions or action-value functions. These functions of states, or of state-action pairs, estimate the value of the agent to be in a given state (or how valuable performing a given action in a given state is). The idea of ‘value’ is defined in terms of future rewards that can be expected by the agent, or, in terms of expected return of the agent. The rewards the agent can expect to receive in the future depend on what actions it will take. Accordingly, value functions are defined with respect to particular policies.

Recall that a policy, π, is a mapping from each state, sϵS, and action aϵA (or aϵA(s)), to the probability π(s,a) of taking action a when in state s. Given these definitions, the policy π is the function F in Equation 4.1. Informally, the value of a state s under a policy π, denoted Vπ(s), is the expected return when starting in s and following π thereafter. For example, we can define Vπ(s) formally as

V^{π}(s)=E_{π}{Rₜ|sₜ=s}=E_{π}{Σₖ₌₀^{∞}γ^{k}rₜ₊ₖ₊₁|sₜ=s} (6.1)

where Eπ{ } denotes the expected value given that the agent follows policy π, γ is a weight function, and t is any time step. Note that the value of the terminal state, if any, is generally zero. The function Vπ the state-value function for policy π.

Similarly, we define the value of taking action a in state s under a policy π, denoted Qπ(s,a), as the expected return starting from s, taking the action a, and thereafter following policy π:

Q^{π}(s,a)=E_{π}{Rₜ|sₜ=s,aₜ=a}=E_{π}{Σₖ₌₀^{∞}γ^{k}rₜ₊ₖ₊₁|sₜ=s|aₜ=a} (6.2)

where En{ } denotes the expected value given that the agent follows policy π, γ is a weight function, and t is any time step. Note that the value of the terminal state, if any, is generally zero. The function Qπ, can be called the action-value function for policy π.

The value functions Vπ and Qπ can be estimated from experience. For example, if an agent follows policy π and maintains an average, for each state encountered, of the actual returns that have followed that state, then the average will converge to the state's value, Vπ(s), as the number of times that state is encountered approaches infinity. If separate averages are kept for each action taken in a state, then these averages will similarly converge to the action values, Qπ(s,a). We call estimation methods of this kind Monte Carlo (MC) methods because they involve averaging over many random samples of actual returns. In some cases, there are many states and it may not be practical to keep separate averages for each state individually. Instead, the agent can maintain Vπ and Qπ as parameterized functions and adjust the parameters to better match the observed returns. This can also produce accurate estimates, although much depends on the nature of the parameterized function approximator.

One property of state-value functions and action-value functions used in reinforcement learning and dynamic programming is that they satisfy particular recursive relationships. For any policy π and any state s, the following consistency condition holds between the value of s and the value of its possible successor states:

$$\begin{matrix}{V}^{π} ( s ) = {E}_{π} \{ {R}_{t} \vert {s}_{t} = s \} & ( 6.3 ) \\ = {E}_{π} \{ {\sum }_{k = 0}^{∞} {γ}^{k} {r}_{t + k + 1} \vert {s}_{t} = s \} & ( 6.4 ) \\ = {E}_{π} \{ {r}_{t + 1} + γ {\sum }_{k = 0}^{∞} {γ}^{k} {r}_{t + k + 2} \vert {s}_{t} = s \} & ( 6.5 ) \\ = {\sum }_{a} π ( s , a ) {\sum }_{{s}^{′}} {P}_{{ss}^{′}}^{a} [ {R}_{{ss}^{′}}^{a} + γ {V}^{π} ( {s}^{′} ) ] & ( 6.6 )\end{matrix}$$

where P are a set of transition probabilities between subsequent states from the actions a taken from the set A(s), R represents expected immediate rewards from the actions a taken from the set A(s), and the subsequent states s′ are taken from the set S, or from the set S′ in the case of an episodic problem. This equation is the Bellman equation for Vπ. The Bellman equation expresses a relationship between the value of a state and the values of its successor states. More simply, this equation is a way of visualizing the transition from one state to its possible successor states. From each of these, the environment could respond with one of several subsequent states s′ along with a reward r. The Bellman equation averages over all the possibilities, weighting each by its probability of occurring. The equation states that the value of the initial state equal the (discounted) value of the expected next state, plus the reward expected along the way. The value function Vπ is the unique solution to its Bellman equation. These operations transfer value information back to a state (or a state-action pair) from its successor states (or state-action pairs).

VI.B Policy Iteration

Continuing with methods used in reinforcement learning systems, the description turns to policy iteration. Once a policy, π, has been improved using Vπ to yield a better policy, π′, the system can then compute Vπ′ and improve it again to yield an even better π″. The system then determines a sequence of monotonically improving policies and value functions:

$${π}_{0} {\to }^{E} {V}^{{π}_{0}} {\to }^{E} {V}^{{π}_{1}} {\to }^{I} {π}_{2} {\to }^{E} … {\to }^{I} {π}^{*} {⇒}^{E} {V}^{*} \qquad ( 6.7 )$$

where E denotes a policy evaluation and I denotes a policy improvement. Each policy is generally an improvement over the previous policy (unless it is already optimal). In reinforcement learning models that have only a finite number of policies, this process can converge to an optimal policy and optimal value function in a finite number of iterations.

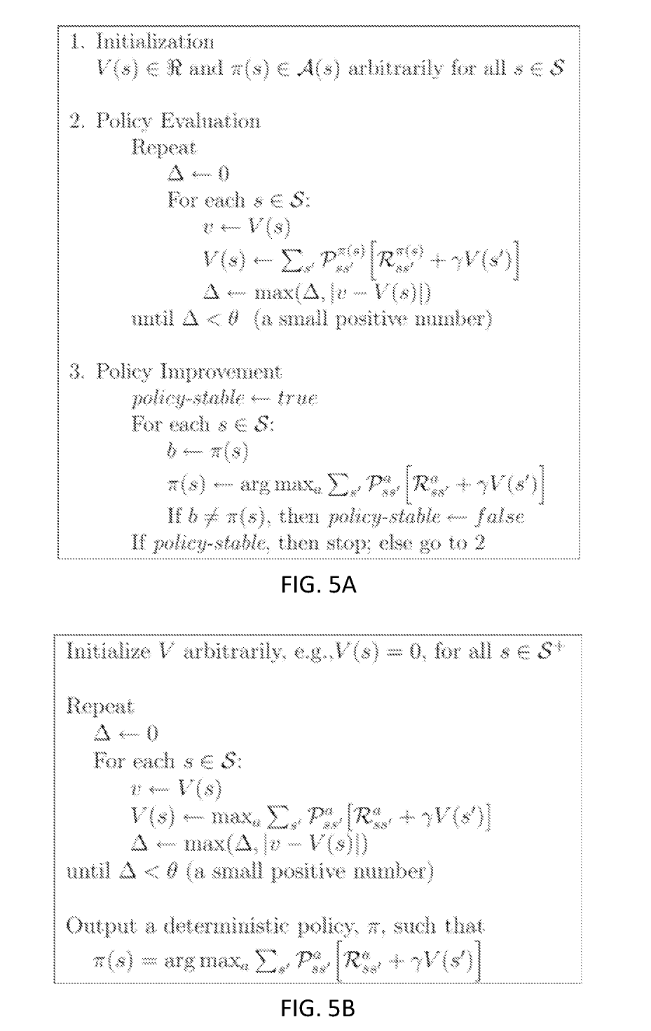

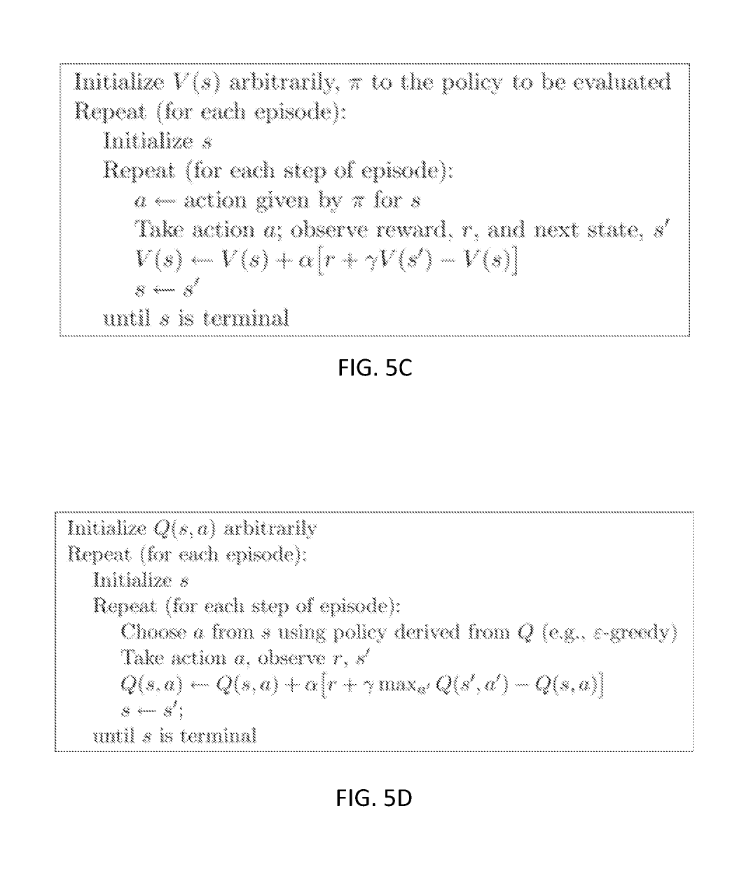

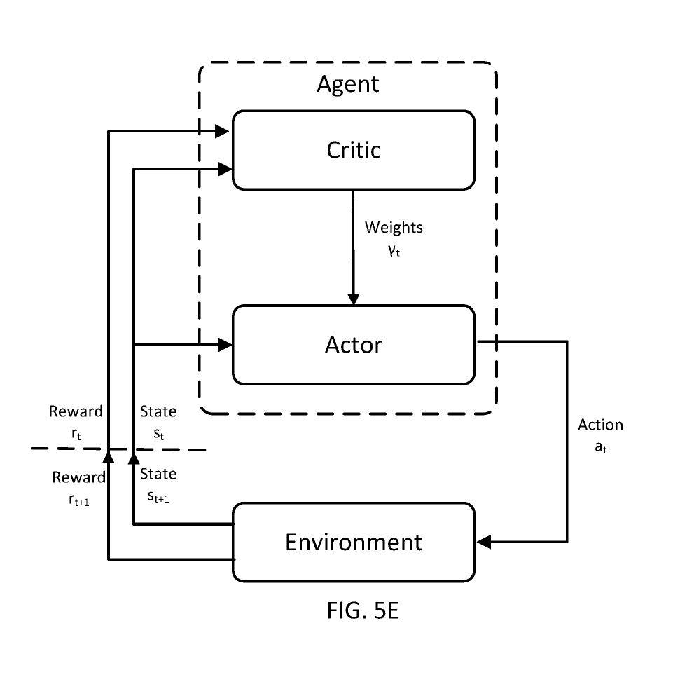

This way of finding an optimal policy is called policy iteration. An example model for policy iteration is given if FIG. 5A. Note that each policy evaluation, itself an iterative computation, begins with the value (either state or action) function for the previous policy. Typically, this results in an increase in the speed of convergence of policy evaluation.

VI.C Value Iteration

Continuing with methods used in reinforcement learning systems, the description turns to value iteration. Value iteration is a special case of policy iteration in which the policy evaluation is stopped after just one sweep (one backup of each state). It can be written as a particularly simple backup operation that combines the policy improvement and truncated policy evaluation steps:

$$\begin{matrix}{V}_{k + 1} ( s ) = {max}_{a} {E}_{π} \{ {r}_{t + 1} + γ {V}_{k} ( {s}_{t + 1} ) \vert {s}_{t} = s \vert {a}_{t} = a \} & ( 6.8 ) \\ = {max}_{a} {\sum }_{a} π ( s , a ) {\sum }_{{s}^{′}} {P}_{{ss}^{′}}^{a} [ {R}_{{ss}^{′}}^{a} + γ {V}^{π} ( {s}^{′} ) ] & ( 6.9 )\end{matrix}$$

for all sϵS, where maxₐ selects the highest value function. For an arbitrary V0, the sequence {Vk} can be shown to converge to V* under the same conditions that guarantee the existence of V*.

Another way of understanding value iteration is by reference to the Bellman equation (previously described). Note that value iteration is obtained simply by turning the Bellman equation into an update rule to a model for reinforcement learning. Further, note how the value iteration backup is similar to the policy evaluation backup except that the maximum is taken over all actions. Another way of seeing this close relationship is to compare the backup diagrams for these models. These two are the natural backup operations for computing Vπ and V*.

Similar to policy evaluation, value iteration formally uses an infinite number of iterations to converge exactly to V*. In practice, value iteration terminates once the value function changes by only a small amount in an incremental step. FIG. 5B gives an example value iteration model with this kind of termination condition.

Value iteration effectively combines, in each of its sweeps, one sweep of policy evaluation and one sweep of policy improvement. Faster convergence is often achieved by interposing multiple policy evaluation sweeps between each policy improvement sweep. In general, the entire class of truncated policy iteration models can be thought of as sequences of sweeps, some of which use policy evaluation backups and some of which use value iteration backups. Since the maxₐ operation is the only difference between these backups, this indicates that the maxₐ operation is added to some sweeps of policy evaluation.

VI.D Temporal-Difference Learning

Both temporal difference (TD) and MC methods use experience to solve the prediction problem. Given some experience following a policy π, both methods update their estimate V of V*. If a nonterminal state st is visited at time t, then both methods update their estimate V(st) based on what happens after that visit. Roughly speaking, Monte Carlo methods wait until the return following the visit is known, then use that return as a target for V(sₜ). A simple every-visit MC method suitable for nonstationary environments is

V(sₜ)←V(sₜ)+α[Rₜ−V(sₜ)] (6.11)

where Rₜ is the actual return following time t and a is a constant step-size parameter. Generally, MC methods wait until the end of the episode to determine the increment to V(sₜ) and only then is Rₜ known, while TD methods need wait only until the next time step. At time t+1 TD methods immediately form a target and make an update using the observed reward rt+1 and the estimate V(sₜ₊₁). The simplest TD method, known as TD(t=0), is

V(sₜ)←V(sₜ)+α[rₜ₊₁+γV(sₜ₊₁)−V(sₜ)] (6.12)

In effect, the target for the Monte Carlo update is Rₜ, whereas the target for the TD update is

rₜ₊₁+γV(sₜ₊₁) (6.13)

Because the TD method bases its update in part on an existing estimate, we say that it is a bootstrapping method. From previously,

$$\begin{matrix}{V}^{π} ( s ) = {E}_{π} \{ {\sum }_{k = 0}^{∞} {γ}^{k} {r}_{t + k + 1} \vert {s}_{t} = s \} & ( 6.14 ) \\ = {E}_{π} \{ {r}_{t + 1} + γ {\sum }_{k = 0}^{∞} {γ}^{k} {r}_{t + k + 2} \vert {s}_{t} = s \} & ( 6.15 )\end{matrix}$$

Roughly speaking, Monte Carlo methods use an estimate of 6.14 as a target, whereas other methods use an estimate of 6.15 as a target. The MC target is an estimate because the expected value in 6.14 is not known; a sample return is used in place of the real expected return. The other method target is an estimate not because of the expected values, which are assumed to be completely provided by a model of the environment, but because Vπ(sₜ₊₁) is not known and the current estimate, Vt(sₜ₊₁) is used instead. The TD target is an estimate for both reasons: it samples the expected values in 6.15 and it uses the current estimate Vₜ instead of the true V_{π}. Thus, TD methods combine the sampling of MC with the bootstrapping of other reinforcement learning methods.

We refer to TD and Monte Carlo updates as sample backups because they involve looking ahead to a sample successor state (or state-action pair), using the value of the successor and the reward along the way to compute a backed-up value, and then changing the value of the original state (or state-action pair) accordingly. Sample backups differ from the full backups of DP methods in that they are based on a single sample successor rather than on a complete distribution of all possible successors. An example model for temporal-difference calculations is given in procedural from in FIG. 5C.

VI.E Q-Learning

Another method used in reinforcement learning systems is an off-policy TD control model known as Q-learning. Its simplest form, one-step Q-learning, is defined by

Q(sₜ,aₜ)←Q(sₜ,aₜ)+α[rₜ₊₁+γmaxₐQ(sₜ₊₁a)−Q(sₜ,aₜ)] (6.16)

In this case, the learned action-value function Q directly approximates Q*, the optimal action-value function, independent of the policy being followed. This simplifies the analysis of the model and enabled early convergence proofs. The policy still has an effect in that it determines which state-action pairs are visited and updated. However, all that is required for correct convergence is that all pairs continue to be updated. This is a minimal requirement in the sense that any method guaranteed to find optimal behavior in the general case uses it. Under this assumption and a variant of the usual stochastic approximation conditions on the sequence of step-size parameters has been shown to converge with probability 1 to Q*. The Q-learning model is shown in procedural form in FIG. 5D.

VI.F Value Prediction

Other methods used in reinforcement learning systems use value prediction. Generally, the discussed methods are trying to predict that an action taken in the environment will increase the reward within the agent environment system. Viewing each backup (i.e. previous state or action-state pair) as a conventional training example in this way enables us to use any of a wide range of existing function approximation methods for value prediction. In reinforcement learning, it is important that learning be able to occur on-line, while interacting with the environment or with a model (e.g., a dynamic model) of the environment. To do this involves methods that are able to learn efficiently from incrementally acquired data. In addition, reinforcement learning generally uses function approximation methods able to handle nonstationary target functions (target functions that change over time). Even if the policy remains the same, the target values of training examples are nonstationary if they are generated by bootstrapping methods (TD). Methods that cannot easily handle such nonstationary are less suitable for reinforcement learning.

VI.G Actor-Critic Training

Another example of a reinforcement learning method is an actor critic-method. The actor-critic method can use temporal difference methods or direct policy search methods to determine a policy for the agent. The actor-critic method includes an agent with an actor and a critic. The actor inputs determined state information about the environment and weight functions for the policy and outputs an action. The critic inputs state information about the environment and a reward determined from the states and outputs the weight functions for the actor. The actor and critic work in conjunction to develop a policy for the agent that maximizes the rewards for actions. FIG. 5E illustrates an example of an agent-environment interface for an agent including an actor and critic.

VI.H Additional Information

Further description of various elements of reinforcement learning can be found in the publications, “Playing Atari with Deep Reinforcement Learning” by Mnih et. al., “Continuous Control with Deep Reinforcement Learning” by Lillicrap et. al., and “Asynchronous Methods for Deep Reinforcement Learning” by Mnih et. al, all of which are incorporated by reference herein in their entirety.

### VII. Neural Networks and Reinforcement Learning

The model 342 described in Section V and Section VI can also be implemented using an artificial neural network (ANN). That is, the agent 340 executes a model 342 that is an ANN. The model 342 including an ANN determines output action vectors (machine commands) for the machine 100 using input state vectors (measurements). The ANN has been trained such that determined actions from elements of the output action vectors increase the performance of the machine 100.

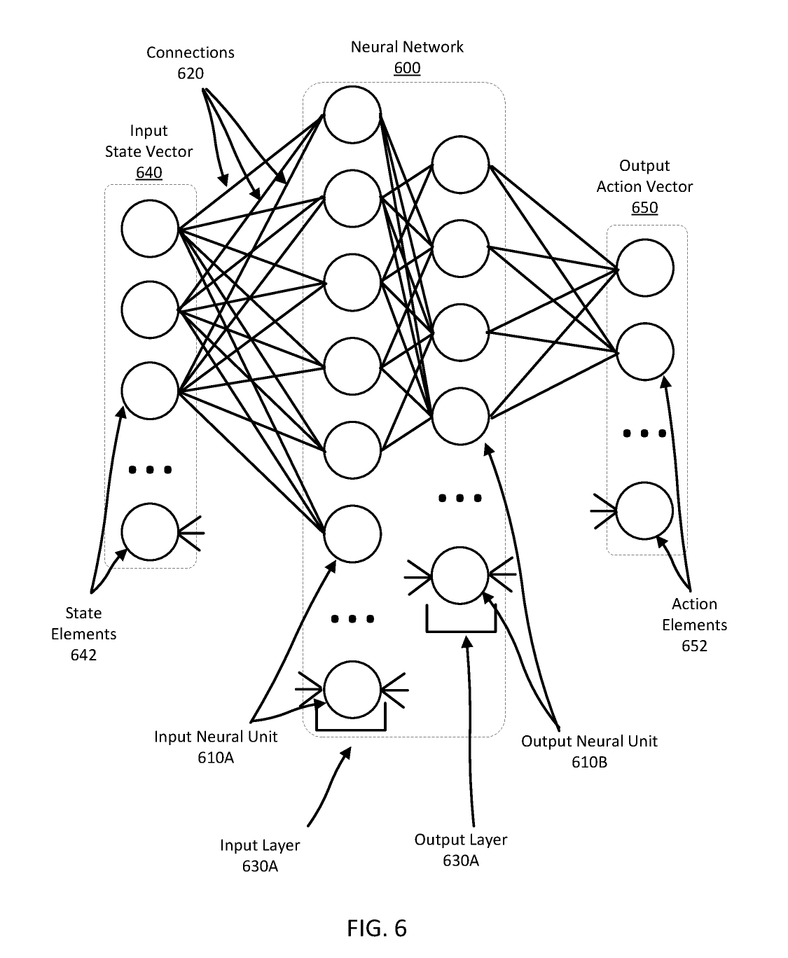

FIG. 6 is an illustration of an ANN 600 of the model 342, according to one example embodiment. The ANN 600 is based on a large collection of simple neural units 610. A neural unit 610 can be an action a, a state s, or any function relating actions a and states s for the machine 100. Each neural unit 610 is connected with many others, and connections 620 can enhance or inhibit adjoining neural units. Each individual neural unit 610 can compute using a summation function based on all of the incoming connections 620. There may be a threshold function or limiting function on each connection 620 and on each neural unit itself 610, such that the neural units signal must surpass the limit before propagating to other neurons. These systems are self-learning and trained (using methods descried in Section VI), rather than explicitly programmed. Here, the goal of the ANN is to improve machine 100 performance by providing outputs to carry out actions to interact with an environment, learning from those actions, and using the information learned to influence actions towards a future goal. In one embodiment, the learning process to train the ANN is similar to policies and policy iteration described above. For example, in one embodiment, a machine 100 takes a first pass through a field to harvest a crop. Based on measurements of the machine state, the agent 340 determines a reward which is used to train the agent 340. Each pass through the field the agent 340 continually trains itself using a policy iteration reinforcement learning model to improve machine performance.

The neural network of FIG. 6 includes two layers 630: an input layer 630A and an output layer 630B. The input layer 630A has input neural units 610A which send data via connections 620 to the output neural units 610B of the output layer 630B. In other configurations, an ANN can include additional hidden layers between the input layer 630A and the output layer 630B. The hidden layers can have neural units 610 connected to the input layer 610A, the output layer 610B, or other hidden layers depending on the configuration of the ANN. Each layer can have any number of neural units 610 and can be connected to any number of neural units 610 in an adjacent layer 630. The connections 620 between neural layers can represent and store parameters, herein referred to as weights, that affect the selection and propagation of data from a particular layers neural units 610 to an adjacent layers neural units 610. Reinforcement learning trains the various connections 620 and weights such that the output of the ANN 600 generated from the input to the ANN 600 improves machine 100 performance. Finally, each neural unit 610 can be governed by an activation function that converts a neural units weighted input to its output activation (i.e., activating a neural unit in a given layer). Some example activation functions that can be used are: the softmax, identify, binary step, logistic, tan H, Arc Tan, softsign, rectified linear unit, parametric rectified linear, bent identity, sing, Gaussian, or any other activation function for neural networks.

Mathematically, an ANN's function (F(s), as introduced above) is defined as a composition of other sub-functions gᵢ(x), which can further be defined as a composition of other sub-sub-functions. The ANN's function is a representation of the structure of interconnecting neural units and that function can work to increase agent performance in the environment. The function, generally, can provide a smooth transition for the agent towards improved performance as input state vectors change and the agent takes actions.

Most generally, the ANN 600 can use the input neural units 610A and generate an output via the output neural units 610B. In some configurations, input neural units 610A of the input layer can be connected to an input state vector 640 (e.g., s). The input state vector 640 can include any information regarding current or previous states, actions, and rewards of the agent in the environment (state elements 642). Each state element 642 of the input state vector 640 can be connected to any number of input neural units 610A. The input state vector 640 can be connected to the input neural units 610A such that ANN 600 can generate an output at the output neural units 610B in the output layer 630A. The output neural units 610B can represent and influence the actions taken by the agent 340 executing the model 442. In some configurations, the output neural units 610B can be connected to any number of action elements 652 of an output action vector (e.g., a). Each action element can represent an action the agent can take to improve machine 100 performance. In another configuration, the output neural units 610B themselves are elements of an output action vector.

### VI. A Agent Training Using Two ANNs

In one embodiment, similar to FIG. 5E, the agent 340 can execute a model 342 using an ANN trained using an actor-critic training method (as described in Section VI). The actor and critic are two similarly configured ANNs in that the input neural units, output neural units, input layers, output layers, and connections are similar when the ANNs are initialized. At each iteration of training, the actor ANN receives as input an input state vector and, together with the weight functions (for example, γ as described above) that make up the actor ANN (as they exist at that time step), outputs an output action vector. The weight functions define the weights for the connections connecting the neural units of the ANN. The agent takes an action in the environment that can affect the state and the agent measures the state. The critic ANN receives as input an input state vector and a reward state vector and, together with the weight functions that make up the critic ANN, outputs weight functions to be provided to the actor ANN. The reward state vector is used to modify the weighted connections in the critic ANN such that the outputted weights functions for the actor ANN improve machine performance. This process continues for every time step, with the critic ANN receiving rewards and states as input and providing weights to the actor ANN as outputs, and the actor ANN receiving weights and rewards as inputs and providing an action for the agent as output.

The actor-critic pair of ANNs work in conjunction to determine a policy that generates output action vectors representing actions that improve combine performance from input state vectors measured from the environment. After training, the actor-critic pair is said to have determined a policy, the critic ANN is discarded and the actor ANN is used as the model 342 for the agent 340.

In this example the reward data vector can include elements with each element representing a measure of a performance metric of the combine after executing an action. The performance metrics can include, in one example, an amount of grain harvested, a threshing quality, a harvested grain cleanliness, a combine throughput, and a grain loss. The performance metrics can be determined from any of the measurements received from the sensors 330. Each element of the reward data vector is associated with a weight defining a priority for each performance metric such that certain performance metrics can be prioritized over other performance metrics. In one embodiment, the reward vector is a linear combination of the different metrics. In some examples, the operator of the combine can determine the weights for each performance metric by interacting with the interface 350 of the control system. For example, the operator can input that grain cleanliness is prioritized relative to thresher quality, and deprioritized relative to the amount of grain harvested. The critic ANN determines a weight function including a number of modified weights for the connections in the actor ANN based on the input state vector and the reward data vector.

Training the ANN can be accomplished using real data obtained from machines operating in a plant field. Thus, in one configuration, the ANNs of the actor-critic method can be trained using a set of input state vectors from any number of combines taking any number of actions based on an output action vectors when harvesting plants in the field. The input state vectors and output action vectors can be accessed from memory of the control systems 130 of various combines.

However, training ANNs can require a large amount of data that is challenging to cheaply obtain from machines operating in a field. Thus, in another configuration, the ANNs of the actor-critic method can be trained using a set of simulated input state vectors and simulated output action vectors. The simulated vectors can be generated from a set of seed input state vectors and seed output action vectors obtained from combines harvesting plants. In this example, in some configurations, the simulated input state vectors and simulated output action vectors can originate from an ANN configured to generate actions that improve machine performance.

### VIII Agent for a Combine

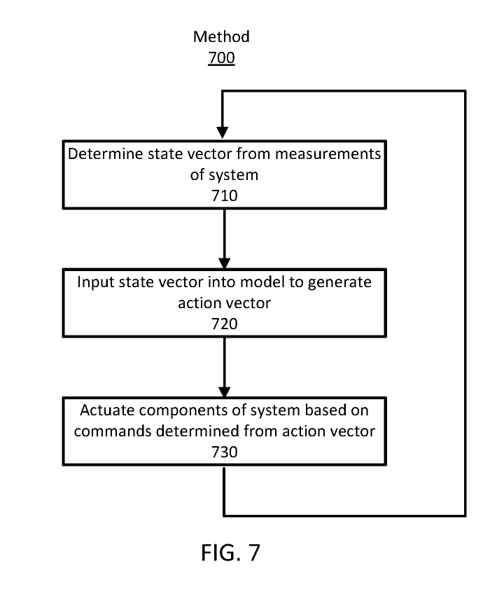

This section describes an agent 340 executing a model 342 for improving the performance of a combine 200. In this example, model 342 is a reinforcement learning model implemented using an artificial neural net similar to the ANN of FIG. 6. That is, the ANN includes an input layer including a number of input neural units and an output layer including a number of output neural units. Each input neural unit is connected to any number of the output neural units by any number of weighted connections. The agent 340 inputs measurements of the combine 200 to the input neural units and the model outputs actions for the combine 200 to the output neural units. The agent 340 determines a set of machine commands based on the output neural units representing actions for the combine that improves combine performance. FIG. 7 is a method 700 for generating actions that improve combine performance using an agent executing 340 a model 342 including an artificial neural net trained using an actor-critic method. Method 700 can include any number of additional or fewer steps, or the steps may be accomplished in a different order.

First, the agent determines 710 an input state vector for the model 342. The elements of the input state vector can be determined from any number of measurements received from the sensors 330 via the network 310. Each measurement is a measure of a state of the machine 100.

Next, the agent inputs 720 the input state vector into the model 342. Each element of the input vector is connected to any number of the input neural units. The model 342 represents a function configured to generate actions to improve the performance of the combine 200 from the input state vector. Accordingly, the model 342 generates an output in the output neural units predicted to improve the performance of the combine. In one example embodiment, the output neural units are connected to the elements of an output action vector and each output neural unit can be connected to any element of the output action vector. Each element of the output action vector is an action executable by a component 120 of the combine 200. In some examples, the agent 340 determines a set of machine commands for the components 120 based on the elements of the output action vector.

Next, the agent 340 sends the machine commands to the input controllers 330 for their components 120 and the input controllers 330 actuate 730 the components 120 based on the machine commands in response. Actuating 730 the components 120 executes the action determined by the model 342. Further, actuating 730 the components 120 changes the state of the environment and sensors 330 measure the change of the state.

The agent 340 again determines 710 an input state vector to input 720 into the model and determine an output action and associated machine commands that actuate 730 components of the combine as the combine travels through the field and harvests plants. Over time, the agent 340 works to increase the performance of the combine 200 when harvesting plants.

Table 1 describes various states that can be included in an input data vector. Table 1 also includes each states associated measurement m, the sensor(s) 330 that generate the measurement m, and a description of the measurement. The input data vector can additionally or alternatively include any other states determined from measurements generated from sensors of the combine 200. For example, in some configurations, the input state vector can include previously determined states from previous measurements m. In this case, the previously determined states (or measurements) can be stored in memory systems of the control system 130. In another example, the input state vector can include changes between the current state and a previous state.

TABLE 1
States included in an input vector.

| State (s) | Meas. (m) | Sensor | Description |
|---|---|---|---|
| Tailings Level | % | Tailings | Amount of usable grain over total |
| | | 366 | MOG material. |
| Separator Loss | # | Separator Loss | Number of grain elements |
| | | 219 | contacting the separator loss sensor |
| Shoe Loss | # | Shoe Loss | Number of grains hitting contacting |
| | | 221/223 | the shoe loss sensors |
| Threshing Loss | % | Threshing Load | Number of grain elements |
| | | 368 | contacting the threshing load sensor |
| Grain Damage | % | Grain Quality | Amount of damaged grain over |
| | | 370 | amount of usable grain |
| MOG-L | % | Grain Quality | Amount of light MOG over amount |
| | | 370 | of usable grain |
| MOG-H | % | Grain Quality | Amount of heavy MOG over |
| | | 370 | amount of usable grain |
| Un-threshed | % | Grain Quality | Amount of un-threshed material |
| | | 370 | over amount of usable grain |

Table 2 describes various actions that can be included in an output action vector. Table 2 also includes the machine controller that receives machine commands based on the actions included output action vector, a high-level description of how each input controller 320 actuates their respective components 120, and the units of the actuation change.

TABLE 1
States included in an input vector.

| Action (a) | Controller | Description | Units |
|---|---|---|---|
| Vehicle | Vehicle | Change the speed of the combine | mph |
| Speed | 388 | using engine. | |
| Rotor Speed | Rotor | Change the rotation speed of the | rpm |
| | 384 | rotor using engine. | |
| Threshing | Threshing Gap | Change the separation between | mm |
| Clearance | 390 | the rotor and threshing basket | |
| Vane | Threshing Gap | Change the angle of the threshing | deg |
| Angle | 390 | vane relative to incoming crop | |
| Upper Sieve | Upper Sieve | Change the sieve separation for | mm |
| Opening | 380 | the upper sieve | |
| Lower Sieve | Lower Sieve | Change the sieve separation for | mm |
| Opening | 382 | the lower sieve | |
| Fan Speed | Fan | Change the speed of the fan | rpm |
| | 386 | | |
| Header | Header | Change the height of the header | mm |
| Height | 392 | relative to the ground | |

In one example, the agent 340 is executing a model 442 that is not actively being trained using the reinforcement techniques described in Section VI. In this case, the agent can be a model that was independently trained using the actor critic methods described in Section VII.A. That is, the agent is not actively rewarding connections in the neural network. The agent can also include various models that have been trained to optimize different performance metrics of the combine. The user of the combine can select between performance metrics to optimize, and thereby change the models, using the interface of the control system 130.

In other examples, the agent can be actively training the model 442 using reinforcement techniques. In this case, the model 342 generates a reward vector including a weight function that modifies the weights of any of the connections included in the model 342. The reward vector can be configured to reward various metrics including the performance of the combine as a whole, reward a state, reward a change in state, etc. In some examples, the user of the combine can select which metrics to reward using the interface of the control system 130.

### IX. Control System

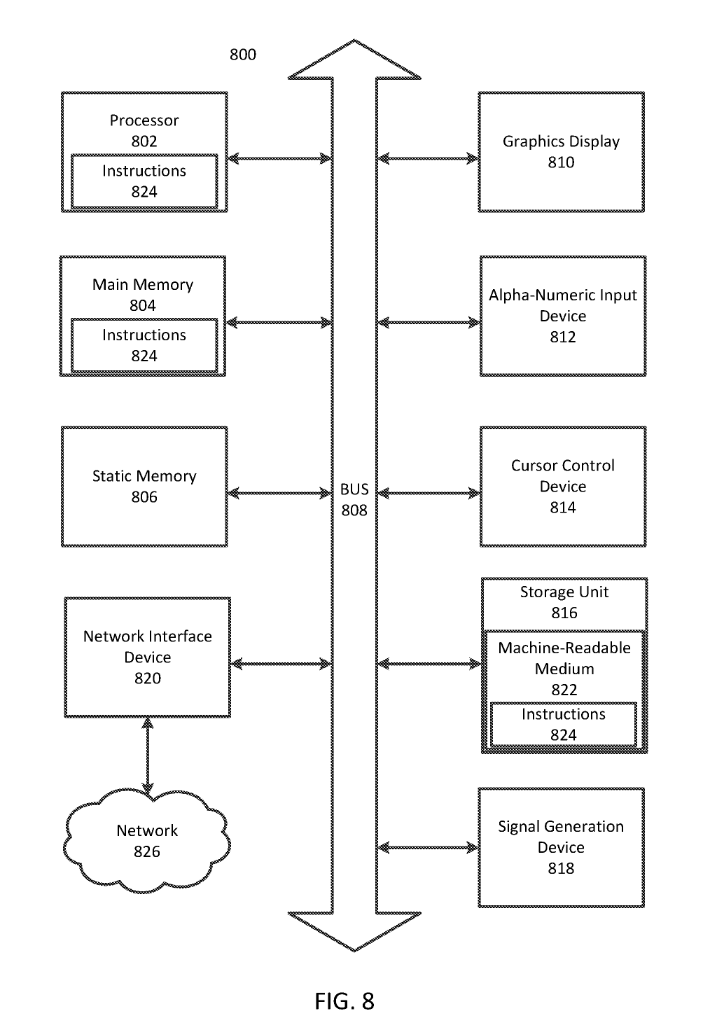

FIG. 8 is a block diagram illustrating components of an example machine for reading and executing instructions from a machine-readable medium. Specifically, FIG. 8 shows a diagrammatic representation of network system 300 and control system 310 in the example form of a computer system 800. The computer system 800 can be used to execute instructions 824 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 800 also includes a main memory 804. The computer system may include a storage unit 816. The processor 802, memory 804, and the storage unit 816 communicate via a bus 808.

In addition, the computer system 806 can include a static memory 806, a graphics display 810 (e.g., to drive a plasma display panel (PDP), a liquid crystal display (LCD), or a projector). The computer system 800 may also include alphanumeric input device 812 (e.g., a keyboard), a cursor control device 814 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. For example, the instructions 824 may include the functionalities of modules of the system 130 described in FIG. 2. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 826 via the network interface device 820.

### X. Additional Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine 100. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for detecting potential malware using behavioral scanning analysis through the disclosed principles herein. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method for controlling the actuation mechanisms of a plurality of components of a combine to harvest plants as the combine travels through a plant field, the method comprising:
determining a state vector comprising a plurality of state elements, each of the state elements representing a measurement a state of a subset of the components of the combine, each of the components controlled by an actuation controller communicatively coupled to a computer mounted on the combine;
inputting, using the computer, the state vector into a control model to generate an action vector comprising a plurality of action elements for the combine, each of the action elements specifying an action to be taken by the combine in the plant field, the actions, in aggregate, predicted to achieve improved harvesting performance for the combine; and
actuating a subset of actuation controllers to execute the actions in the plant field based on the action vector, the subset of controllers changing a configuration of the subset of components such that the state of the combine changes.

2. The method of claim 1, wherein the control model comprises a function representing the relationship between the state vector received as an input to the control model and the action vector generated as an output to the control model, and the function is a model trained using reinforcement learning to reward actions that improve the harvesting performance of the combine.

3. The method of claim 1 wherein the control model comprises an artificial neural network comprising:
a plurality of neural nodes including a set of input nodes for receiving an input to the artificial neural network and a set of output nodes for outputting an output to the artificial neural network, where
each neural node represents a sub-function for determining an output for the artificial neural network from the input of the artificial neural network, and
each input node is connected to one or more output nodes by a connection of a plurality of weighted connections; and
a function configured to generate actions for the combine which improve the combine performance, the function defined by the sub-functions and weighted connections of the artificial neural network.

4. The method of claim 3, wherein
each state element of the state vector is connected to one or more input nodes by a connection of the plurality of weighted connections,
each action element of the action vector is connected to one or more output nodes by a connection of the plurality of weighted connections, and
the function is configured to generate action elements of the action vector from state elements of the state vector.

5. The method of claim 3, wherein the artificial neural network is a first artificial neural network from a pair of similarly configured artificial neural networks acting as an actor-critic pair and used to train the first artificial neural network to generate actions that improve the combine performance.

6. The method of claim 5, wherein
the first neural network inputs state vectors and values for the weighted connections and outputs action vectors, the values for the weighted connections modifying the function for generating actions for the combine that improve combine performance, and
the second neural network inputting a reward vector and a state vector and outputting the values for the weighted connections, the reward vector comprising elements signifying the improvement in performance of the combine from a previously executed action.

7. The method of claim 5 wherein the elements of the reward vector are determined using measurements of the capabilities of a subset the components of the combine that were previously actuated based on the previously executed action.

8. The method of claim 5, wherein the operator can select a metric for performance improvement, the metrics including any of throughput, plant cleanliness, amount of plant harvested, quality of plant harvested, quality of plant threshed, and amount of plant loss.

9. The method of claim 5, wherein the state vectors are obtained from plurality of combines taking a plurality of actions from a plurality of action vectors to harvest plants in the plant field.

10. The method of claim 5, wherein the state vectors and action vectors are simulated from a set of seed state vectors obtained from a plurality of combines taking a set of actions from a seed set of action vectors to harvest plants in the plant field.

11. The method of claim 1, wherein determining a state data vector comprises:
accessing a datastream communicatively coupling a plurality of sensors, each sensor for providing a measurement of one of the capabilities of a subset of the components of the combine; and
determining the elements of the state vector based on the measurements included in the the datastream.

12. The method of claim 11, wherein the plurality of sensors can include any of a threshing gap sensor, a tailings level sensor, a separator loss sensor, a shoe loss sensor, a grain damage sensor, a material other than grain sensor, and an unthreshed grain sensor.

13. The method of claim 1, wherein the state elements include any of:
a tailings level representing a ratio of usable plant to material other than plant in the tailings of a cleaning shoe component of the combine;
a separator loss representing an amount of the plant lost at a separator component of the combine;
a shoe loss representing an amount of the plant lost at a shoe component of the combine;
a threshing loss representing an amount of the plant lost at a threshing component of the combine;
a grain damage representing an amount of damaged plant in a grain tank component of the combine;
a light material other than plant representing a ratio of usable plant and light material other than plant in the grain tank component of the combine;
a heavy material other than plant representing a ratio of usable plant and heavy material other than plant in the grain tank component of the combine; and
an unthreshed plant representing a ratio of usable plant and unthreshed plant in a grain tank component of the combine.

14. The method of claim 1, wherein actuation a subset of actuation controllers comprises:
determining a set of machine instructions each actuation controller of the subset such that the machine instructions change the configuration of each component when received by the actuation controller;
accessing a datastream communicatively coupling the actuation controllers; and
sending the set of machine instructions to each actuation controller of the subset via the datastream.

15. The method of claim 1, wherein the action elements can specify actions including any of:
modifying a speed of the combine;
modifying a rotor speed of a rotor component of the combine;
modifying a threshing gap distance between a threshing gap component and the rotor component of the combine;
modifying a vane angle between a rotor and a direction of incoming plant material of the combine;
modifying an upper sieve opening;
modifying a lower sieve opening; and
modifying a fan speed of a fan component of the combine.

16. The method of claim 1, wherein the plurality of components of the machine combine can include any of a rotor, an engine, a threshing basket, a head, a upper sieve, a lower sieve, a grain elevator, a grain tank, a fan, a separator vane, or a shoe.

17. The method of claim 1, wherein the components of the combine combine are configured to harvest plants including any of corn, wheat, or rice.

18. The method of claim 1, wherein the action elements of the action vector are numerical representation of the action.

19. The method of claim 1, wherein the state elements of the state vector are a numerical representation of the measurements.
